(19) United States
(12) Patent Application Publication
(10) Pub. No.: US 2022/0236992 A1
(43) Pub. Date: Jul. 28, 2022

(54) RISC-V BRANCH PREDICTION METHOD, DEVICE, ELECTRONIC DEVICE AND STORAGE MEDIUM

(71) Applicant: INSPUR SUZHOU INTELLIGENT TECHNOLOGY CO., LTD., Jiangsu (CN)

(72) Inventors: Tongqiang Liu, Jiangsu (CN); Chaohui Wang, Jiangsu (CN); Rengang Li, Jiangsu (CN); Tuo Li, Jiangsu (CN); Yulong Zhou, Jiangsu (CN); Xiaofeng Zou, Jiangsu (CN)

(21) Appl. No.: 17/613,661

(22) PCT Filed: Aug. 30, 2019
(86) PCT No.: PCT/CN2019/103632

§ 371 Date: Nov. 23, 2021

(30) Foreign Application Priority Data
May 23, 2019 (CN) 201910434279.7

(51) Int. Cl. G06F 9/38; G06F 9/30

(52) U.S. Cl. CPC G06F 9/3806; G06F 9/30069; G06F 9/30058

(57) ABSTRACT

A RISC-V branch prediction method and device, an electronic device and a computer readable storage medium are provided. On the basis of the prior art, the remaining jump times of the jump instruction are additionally acquired, and the single jump step length (the single jump step length is not fixed to be 1) is calculated according to the difference of remaining jump times during two consecutive jumps, whether the target jump instruction has executed the last jump can be judged according to the single jump step length of a jump instruction and in combination with the real-time remaining jump times, so as to determine the jump times that need to be executed subsequently according to the judgment result.

### CROSS REFERENCE TO RELATED APPLICATIONS

This application is the U.S. National Stage of PCT/CN2019/103632 filed Aug. 30, 2019, which claims the priority of Chinese Patent Application 201910434279.7 filed May 23, 2019, the entire contents of which are incorporated herein by reference in its entirety.

### TECHNICAL FIELD

The present application relates to the technical field of RISC-V processors, in particular to an RISC-V branch prediction method and device, an electronic device and a computer readable storage medium.

### BACKGROUND ART

With the complexity of computer systems, it is required that the computer instruction system should be constructed in such a way that the overall performance of the computer is faster and more stable. Initially, in the optimization method adopted by people, some instructions with complex functions are set to enable some commonly used functions that were originally implemented by software to functions that are implemented by the instruction system of hardware, to improve the execution speed of the computer. Such type of computer system is called a complex instruction set computer (CISC).

However, with the development of computer technology, the direction of CISC was found to have many shortcomings, so RISC (Reduced Instruction Set Computer) which is different from the CISC concept has gradually been developed and applied. The basic idea of RISC is to simplify the functions of computer instructions as much as possible, keep only those instructions with simple functions that can be executed in one beat, and use a subroutine to implement more complex functions, such that the average execution cycle of instructions may be reduced, so as to increase the working main frequency of the computer, meanwhile, a large number of general-purpose registers are used to increase the speed of subroutine execution, such that the instructions of the processor can be executed in a pipelined manner.

An RISC-V is commonly used to refer to a reduced instruction set processor that follows the fifth-generation reduced instruction set standard, while in the field of RISC-V processor pipeline processing, the pipelined branch prediction has always been a very important part. The existing RISC-V processor mostly adopts a BHT (branch history table) technology to realize instruction acceleration of branch prediction. As the name implies, the BHT is a table to record branch history information to determine whether a branch instruction is token (jump), or whether the branch instruction is a jump instruction.

Since the BHT only records whether a branch instruction is a jump instruction, if a branch instruction is not only a jump instruction but also requires multiple jumps, the RISC-V processor will also only keep executing the jump operation according to the fact that the branch instruction is a jump instruction, even if the jump instruction has already executed the last jump. That is, through the existing BHT method, whether the jump instruction has completed the preset jump times cannot be judged, it can only be passively discovered only after waiting until an error occurs in the next jump exceeding the preset jump times, which may cause unnecessary waste of computing resources and consumption of extra instruction cycles and reduce the instruction processing efficiency of the processor.

Therefore, for those skilled in the art, how to overcome the above technical shortcomings of the prior art and provide an RISC-V branch prediction mechanism with more reasonable consumption of computing resources and instruction cycles and more efficient processing efficiency of processor instructions has become an urgent problem to be solved.

### SUMMARY OF THE INVENTION

The objective of the present application is to provide an RISC-V branch prediction method and device, an electronic device and a computer readable storage medium, to allow for more reasonable consumption of computing resources and instruction cycles and more efficient processing efficiency of instructions of RISC-V processors.

To achieve the above objective, the present application provides an RISC-V branch prediction method, and the method includes:

acquiring remaining jump times of a target jump instruction;

calculating to obtain a single jump step length according to the remaining jump times respectively corresponding to two consecutive jumps of the target jump instruction;

determining whether the jump to be executed by the target jump instruction is the last jump according to the single jump step length and the remaining jump times;

if the jump to be executed by the target jump instruction is the last jump, executing the last jump on the target jump instruction;

if the jump to be executed by the target jump instruction is not the last jump, proceeding to execute the next jump on the target jump instruction.

Optionally, the determining whether the jump to be executed by the target jump instruction is the last jump according to the single jump step length and the remaining jump times includes:

judging whether the difference between the remaining jump times and the single jump step length is 0;

if the difference between the remaining jump times and the single jump step length is 0, determining that the jump to be executed by the target jump instruction is the last jump;

if the difference between the remaining jump times and the single jump step length is not 0 and the difference is greater than 0, determining that the jump to be executed by the target jump instruction is not the last jump; and

if the difference between the remaining jump times and the single jump step length is not 0 and the difference is less than 0, determining that the jump to be executed by the target jump instruction is the last jump.

Optionally, the RISC-V branch prediction method further includes:

appending a jump end mark to a target jump instruction that does not need to execute the next jump.

To achieve the above objective, the present application further provides an RISC-V branch prediction device, and the device includes:

a remaining jump times acquisition unit, configured to acquire remaining jump times of the target jump instruction;

a single jump step length calculation unit, configured to calculate to obtain a single jump step length according to the remaining jump times respectively corresponding to two consecutive jumps of the target jump instruction;

a last jump judgment unit, configured to determine whether the jump to be executed by the target jump instruction is the last jump according to the single jump step length and the remaining jump times;

a last jump processing unit, configured to execute the last jump on the target jump instruction when determining that the jump to be executed by the target jump instruction is the last jump; and

a non-last jump processing unit, configured to proceed to execute the next jump on the target jump instruction when determining that the jump to be executed by the target jump instruction is not the last jump.

Optionally, the last jump judgment unit includes:

a zero difference judgment subunit, configured to judge whether the difference between the remaining jump times and the single jump step length is 0;

a zero difference judgment subunit, configured to determine that the jump to be executed by the target jump instruction is the last jump if the difference between the remaining jump times and the single jump step length is 0;

a first non-zero difference judgment subunit, configured to determine that the jump to be executed by the target jump instruction is not the last jump if the difference between the remaining jump times and the single jump step length is not 0 and the difference is greater than 0; and

a second non-zero difference judgment subunit, configured to determine that the jump to be executed by the target jump instruction is the last jump if the difference between the remaining jump times and the single jump step length is not 0 and the difference is less than 0.

Optionally, the RISC-V branch prediction device further includes:

a jump end mark appending unit, configured to append a jump end mark to a target jump instruction that does not need to execute the next jump.

To achieve the above objective, the present application further provides an electronic device, and the electronic device includes:

a memory, configured to store a computer program; and

a processor, configured to implement the RISC-V branch prediction method described in the above contents when executing the computer program.

To achieve the above objective, the present application further provides a computer readable storage medium, the computer readable storage medium stores a computer program thereon, and the computer program implements the RISC-V branch prediction method described in the above contents when being implemented by a processor.

Obviously, to solve the shortcomings in the prior art, as to the RISC-V branch prediction method provided in the present application, on the basis of the prior art, the remaining jump times of the jump instruction are additionally acquired, and the single jump step length (the single jump step length is not fixed to be 1) is calculated according to the difference of remaining jump times during two consecutive jumps, whether the target jump instruction has executed the last jump can be judged according to the single jump step length of a jump instruction and in combination with the real-time remaining jump times, so as to determine the jump times that need to be executed subsequently according to the judgment result. Through the above solution, whether a jump instruction has currently executed the last jump can be judged initiatively, compared with the prior art in which the same result is obtained passively, no extra computing resources and instruction cycles need to be consumed, and the processing efficiency of instructions is more efficient.

The present application simultaneously provides an RISC-V branch prediction device, an electronic device and a computer readable storage medium with the above beneficial effects, which will not be repeated redundantly herein.

### BRIEF DESCRIPTION OF THE DRAWINGS

In order to more clearly illustrate the technical solutions in the embodiments of the present application or the prior art, the accompanying drawings to be used in the description of the embodiments or the prior art will be briefly introduced, apparently, the accompanying drawings in the following description are merely embodiments of the present application, and other drawings can be obtained from the provided drawings without any creative effort by those skilled in the art.

FIG. 1 is a flow chart of an RISC-V branch prediction method provided in the embodiment of the present application;

FIG. 2 is a flow chart of a method for determining whether the next jump is required in an RISC-V branch prediction method provided in the embodiment of the present application; and

FIG. 3 is a structural block diagram of an RISC-V branch prediction device provided in the embodiment of the present application.

### DETAILED DESCRIPTION OF THE EMBODIMENTS

The objective of the present application is to provide an RISC-V branch prediction method and device, an electronic device and a computer readable storage medium designed to allow for more reasonable consumption of computing resources and instruction cycles and more efficient processing efficiency of instructions of RISC-V processors.

In order to make the objective, technical solutions and advantages of the embodiments of the present application clearer, the technical solutions in the embodiments of the present application will be described clearly and completely below in combination with the accompanying drawings in the embodiments of the present application, apparently, the described embodiments are a part but not all of the embodiments of the present application. Based on the embodiments in the present application, all the other embodiments obtained by those skilled in the art without any creative effort shall all fall within the protection scope of the present application.

### Embodiment 1

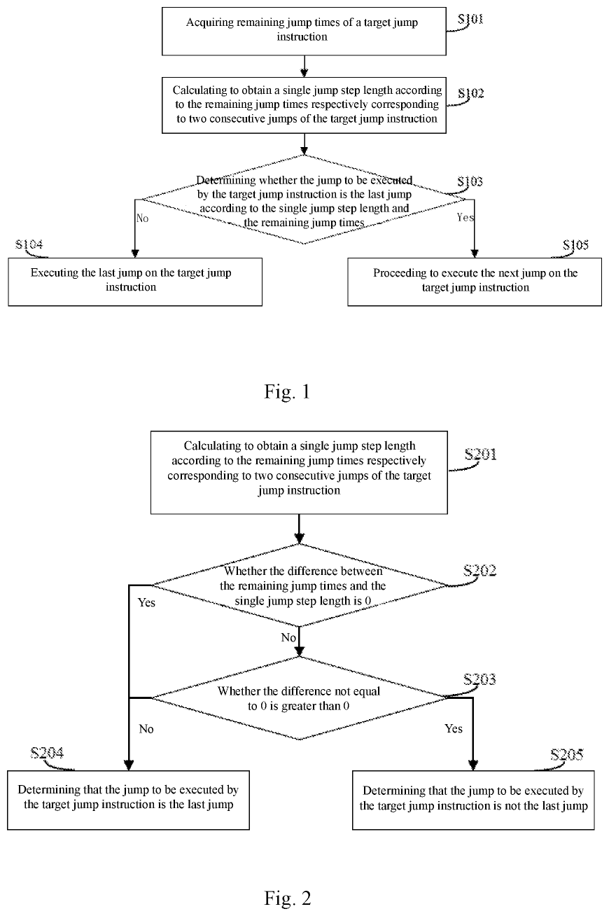

Referring to FIG. 1 which is a flow chart of an RISC-V branch prediction method provided in the embodiment of the present application, and the method includes the following steps:

S101: acquiring remaining jump times of a target jump instruction;

This step aims to acquire the remaining jump times of the target jump instruction, i.e., this step is based on the fact that a branch instruction has already been identified as a jump instruction. As the name implies, the remaining jump times refer to a parameter used to indicate how many times the target jump instructions still needs to jump.

Wherein the target jump instruction is provided by an RISC-V processor, specifically, by a PC register in the RISC-V processor; the remaining jump times can acquire the register address in which the remaining jump times are recorded from some bit fields of the target jump instruction, in order to obtain the remaining jump times from the register by accessing the register address.

S102: calculating to obtain a single jump step length according to the remaining jump times respectively corresponding to two consecutive jumps of the target jump instruction;

On the basis of S101, this step aims to calculate to obtain the single jump step length according to the remaining jump times corresponding to each of the two consecutive jumps of the target jump instruction. The reason for calculating to obtain the single jump step length is that after each jump, not all the jump instructions have a difference of 1 between the current remaining jump times and the remaining jump times before each jump, i.e., the single jump step length is not fixed to 1. In actual cases, there are examples of a single jump step length being equal to 3. If the single jump step length is fixed to 1, then whether the next jump to be executed is the last jump can be rapidly determined only according to whether the real-time remaining jump times are 0. Since the single jump step length is not fixed to 1, for example, when the total jump times are 11 but the single jump step length is 3, the remaining jump times will be 2 after the third jump is executed, which means that the corresponding jump instruction still needs to execute the last jump to complete the preset jump requirement.

Therefore, in order to fully and accurately distinguish whether the next jump to be executed is the last jump, it is necessary to combine both the real-time remaining jump times and the single jump step length.

S103: determining whether the jump to be executed by the target jump instruction is the last jump according to the single jump step length and the remaining jump times; if the jump to be executed by the target jump instruction is the last jump, then performing S105, otherwise, performing S104;

On the basis of S101 and S102, this step aims to determine whether the next jump to be executed by the target jump instruction is the last jump according to the calculated single jump step length and the real-time remaining jump times.

Whether the next jump to be executed by the target jump instruction is the last jump can be determined according to whether the difference between the current remaining jump times and the single jump step length is 0. Since the remaining jump times are only meaningful in the interval greater than or equal to 0, if the single jump step length is 1, then according to the method of subtracting 1 each time, there must be a time when the difference between the two is 0, and when the difference is 0, it means that the current jump is the jump previous to the last jump, that is, the next jump is the last jump; if the single jump step length is not 0, for example, the above example with the total jump times being 11 and the single jump step length being 3, the remaining jump times before the execution of the last jump is 2, then when the next jump is the last jump, the difference is less than 0 since its current remaining jump times are less than 3, then the current remaining jump times are not equal to 0, and further whether the last jump is executed can be judged when the single jump step length is not 0. Of course, if the difference is greater than 0, it means that the next jump is not the last jump and more jumps need to be executed.

S104: executing the last jump on the target jump instruction;

This step is established on the basis of determining that the next jump to be executed by the target jump instruction is the last jump according to the single jump step length and the remaining jump times in S103, then the RISC-V processor will execute only the last jump for the target jump, i.e., no more jumps will be executed after the next jump is executed, and then the jump-out step will be performed since the target jump instruction has executed the preset jump times.

S105: Proceeding to execute the next jump on the target jump instruction.

This step is established on the basis of determining that the next jump to be executed by the target jump instruction is not the last jump according to the single jump step length and the remaining jump times in S103, then the RISC-V processor will continue to perform next jump operation for unlimited times on the target jump instruction, until the jump times required subsequently is modified to 1 in S104 when the next jump to be executed by the target jump instruction is determined to be the last jump according to the single jump step length and the new remaining jump times.

In some special cases, the remaining jump times can be a negative number, such as −100, although the remaining jump times can be represented with negative numbers, accordingly, for the purpose of its consumption, the single jump step length is a positive number, and eventually the remaining jump times tend to become 0 after repeated jumps. It needs to be noted that, the remaining jump times still represent the meaning of positive numbers, that is, negative numbers are only its way of expression in a particular case, and should be understood by using the absolute value.

In order to solve the shortcomings in the prior art, as to the RISC-V branch prediction method provided in the present application, on the basis of the prior art, the remaining jump times of the jump instruction are additionally acquired, and the single jump step length (the single jump step length is not fixed to be 1) is calculated according to the difference of remaining jump times during two consecutive jumps, whether the target jump instruction has executed the last jump can be judged according to the single jump step length of a jump instruction and in combination with the real-time remaining jump times, so as to determine the jump times that need to be executed subsequently according to the judgment result. Through the above solution, whether a jump instruction has currently executed the last jump can be judged initiatively, compared with the prior art in which the same result is obtained passively, no extra computing resources and instruction cycles need to be consumed, and the processing efficiency of instructions is more efficient.

### Embodiment 2

Referring to FIG. 2 which is a flow chart of a method for determining whether the next jump to be executed is the last jump in the RISC-V branch prediction method provided in the embodiment of the present application. Aiming at S103, the present embodiment provides a method for determining whether the jump to be executed by the target jump instruction is the next jump needing to be executed last time according to the difference between the current remaining jump times and the single jump step length, and the method includes the following steps:

S201: calculating to obtain a single jump step length according to the remaining jump times respectively corresponding to two consecutive jumps of the target jump instruction;

this step is the same as S102, for the description of related illustration, Referring to S102, and the same part will not be repeated redundantly herein.

S202: judging whether the difference between the remaining jump times and the single jump step length is 0, if the difference is 0, then performing S204, otherwise, performing S203;

this step aims to judge whether the difference between the current remaining jump times and the single jump step length is 0.

S203: judging whether the difference not equal to 0 is greater than 0, if the difference is greater than 0, then performing S205, otherwise, performing S204;

this step is established on the basis of the judgment result in S202 that the difference between the remaining jump times and the single jump step length is not 0, aiming at judging again whether the difference which is not 0 is specifically greater than 0 or less than 0, since the meanings indicated by greater than 0 and less than 0 are completely different.

S204: determining that the jump to be executed by the target jump instruction is the last jump;

this step is established on the basis that the judgment result of S202 is whether the difference between the remaining jump times and the single jump step length is 0 and the judgment result of S203 is that the difference which is not 0 is less than 0, wherein when the difference is 0, since the single jump step length is 1, before the last jump, the current remaining jump times is 1, then the difference between the current remaining jump times and the single jump step length is 0; even if the single jump is not 1, as long as the total jump times of the target jump instruction are a multiple of the single jump step length, the condition in which the difference between the two is 0 exists, it can be determined that the target jump instruction has already executed the jump previous to the last jump based on the difference which is 0, that is, the next jump is the last jump.

Specially, the condition in which the difference which is not 0 is less than 0 will occur under the condition that the single jump step length is 0 and the total jump times are also not an integral multiple of the single jump step length, aiming at this condition, when the difference is less than 0, the same meaning can still be represented.

S205: determining that the jump to be executed by the target jump instruction is not the last jump.

This step is established on the basis that the judgment result in S203 is that the difference which is not 0 is greater than 0, no matter whether the single jump step length is 1, when the difference is not 0 and the difference is greater than 0, it means that the jump to be executed next time is not the last jump.

Because of the complexity of the situation, it is impossible to enumerate all of them. Those skilled in the art should be able to realize that many examples can exist according to the basic method principles provided in the present application and in combination with the actual situation, and such examples should all fall within the protection scope of the present application without sufficient creative effort.

Specifically, the above-mentioned parameters used to obtain the judgment result can be achieved by additional fields and the expression manner of the meaning accompanying the field in actual conditions, in order to supplement with more information the technical shortcomings of the classical BHT method due to less recorded contents.

### Embodiment 3

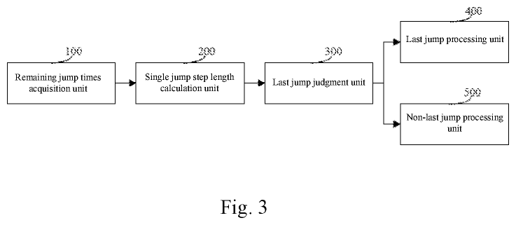

Referring to FIG. 3 below, FIG. 3 is a structural block diagram of an RISC-V branch prediction device provided in an embodiment of the present application, and the device may include:

a remaining jump times acquisition unit 100, configured to acquire remaining jump times of the target jump instruction; a single jump step length calculation unit 200, configured to calculate to obtain a single jump step length according to the remaining jump times respectively corresponding to two consecutive jumps of the target jump instruction;

a last jump judgment unit 300, configured to determine whether the jump to be executed by the target jump instruction is the last jump according to the single jump step length and the remaining jump times;

a last jump processing unit 400, configured to execute the last jump on the target jump instruction when determining that the jump to be executed by the target jump instruction is the last jump; and

a non-last jump processing unit 500, configured to proceed to execute the next jump on the target jump instruction when determining that the jump to be executed by the target jump instruction is not the last jump, wherein the last jump judgment unit 300 may include:

a zero difference judgment subunit, configured to judge whether the difference between the remaining jump times and the single jump step length is 0;

a zero difference judgment subunit, configured to determine that the jump to be executed by the target jump instruction is the last jump if the difference between the remaining jump times and the single jump step length is 0;

a first non-zero difference judgment subunit, configured to determine that the jump to be executed by the target jump instruction is not the last jump if the difference between the remaining jump times and the single jump step length is not 0 and the difference is greater than 0; and

a second non-zero difference judgment subunit, configured to determine that the jump to be executed by the target jump instruction is the last jump if the difference between the remaining jump times and the single jump step length is not 0 and the difference is less than 0.

Further, the RISC-V branch prediction device may further include:

a jump end mark appending unit, configured to append a jump end mark to a target jump instruction that does not need to execute the next jump.

The present embodiment exists as a device embodiment corresponding to the above solution embodiment, and each functional unit corresponds to each step in the method embodiment and contains all the beneficial effects of the method embodiment, which will not be repeated redundantly herein.

Based on the above embodiments, the present application also provides an electronic device, and the electronic device may include a memory and a processor, wherein the memory contains a computer program, and the processor may implement the steps provided in the above embodiments when calling the computer program in the memory. Of course, the electronic device may also include various necessary network interfaces, power supplies, and other components, etc.

Specifically, the electronic device may be a novel RISC-V processor that incorporates the solutions provided in the present application, or a processing device for pipelined branch prediction, etc.

The present application further provides a computer readable storage medium which stores a computer program thereon, and the computer program may implement the steps provided in the above embodiments when being executed by an execution terminal or a processor. The storage medium may include: a USB flash drive, a removable hard disk, a read-only memory (ROM), a random access memory (RAM), a disk or a CD-ROM, and various other media that can store program codes.

Each embodiment in the specification is described in a progressive manner, with each embodiment focusing on the differences from the other embodiments, and the same and similar parts between each embodiment can be referred to each other. For the device disclosed in the embodiment, since it corresponds to the method disclosed in the embodiment, the description is relatively simple, and for the relevant parts, Referring to the description in the method section.

The professionals may further realize that the units and algorithmic steps of each example described in combination with the embodiments disclosed herein are capable of being implemented in electronic hardware, computer software, or a combination of the two, and the composition and steps of each example have been described generally by function in the above description for the purpose of clearly illustrating the interchangeability of hardware and software. Whether these functions are performed in hardware or software depends on the particular application and design constraints of the technical solution. Those skilled in the art may use different methods to implement the described functions for each particular application, but such implementation should not be considered as going beyond the scope of the present application.

Specific examples have been applied herein to illustrate the principles and implementation of the present application, and the above descriptions of the embodiments are merely used to help understand the method of the present application and its core ideas. For those skilled in the art, without departing from the principles of the present application, numerous improvements and modifications can be made to the present application, and such improvements and modifications shall also fall within the protection scope of the claims of the present application.

It should also be noted that in the present specification, relationship terms such as first and second are merely used to distinguish one entity or operation from another entity or operation, and do not necessarily require or imply any such actual relationship or order between these entities or operations. Moreover, the terms “include”, “comprise”, or any other variation thereof are intended to cover non-exclusive inclusion, such that a process, method, article, or device including a set of elements includes not only those elements, but also other elements not expressly listed or also includes elements inherent to such process, method, article, or device. Without further limitation, the inclusion of an element as defined by the statement “including a” does not preclude the existence of additional identical elements in the process, method, article, or device including the element.

1-8. (canceled)

9. An RISC-V branch prediction method, comprising:
acquiring remaining jump times of a target jump instruction;
calculating a single jump step length according to the remaining jump times respectively corresponding to two consecutive jumps of the target jump instruction;
determining whether the jump to be executed by the target jump instruction is the last jump according to the single jump step length and the remaining jump times;
if the jump to be executed by the target jump instruction is the last jump, executing the last jump to the target jump instruction;
if the jump to be executed by the target jump instruction is not the last jump, proceeding to execute the next jump to the target jump instruction.

10. The RISC-V branch prediction method according to claim 9, wherein, the determining whether the jump to be executed by the target jump instruction is the last jump according to the single jump step length and the remaining jump times comprises:
judging whether the difference between the remaining jump times and the single jump step length is 0;
if the difference between the remaining jump times and the single jump step length is 0, determining that the jump to be executed by the target jump instruction is the last jump;
if the difference between the remaining jump times and the single jump step length is not 0 and the difference is greater than 0, determining that the jump to be executed by the target jump instruction is not the last jump; and
if the difference between the remaining jump times and the single jump step length is not 0 and the difference is less than 0, determining that the jump to be executed by the target jump instruction is the last jump.

11. The RISC-V branch prediction method according to claim 9, further comprising:
appending a jump end mark to a target jump instruction that does not need to execute the next jump.

12. The RISC-V branch prediction method according to claim 10, further comprising:
appending a jump end mark to a target jump instruction that does not need to execute the next jump.

13. An electronic device, comprising:
a memory, configured to store a computer program; and
a processor, configured, when executing the computer program, to implement a RISC-V branch prediction method comprising:
acquiring remaining jump times of a target jump instruction;
calculating a single jump step length according to the remaining jump times respectively corresponding to two consecutive jumps of the target jump instruction;
determining whether the jump to be executed by the target jump instruction is the last jump according to the single jump step length and the remaining jump times;
if the jump to be executed by the target jump instruction is the last jump, executing the last jump to the target jump instruction;
if the jump to be executed by the target jump instruction is not the last jump, proceeding to execute the next jump to the target jump instruction.

14. The electronic device according to claim 13, wherein, the determining whether the jump to be executed by the target jump instruction is the last jump according to the single jump step length and the remaining jump times comprises:
judging whether the difference between the remaining jump times and the single jump step length is 0;
if the difference between the remaining jump times and the single jump step length is 0, determining that the jump to be executed by the target jump instruction is the last jump;
if the difference between the remaining jump times and the single jump step length is not 0 and the difference is greater than 0, determining that the jump to be executed by the target jump instruction is not the last jump; and
if the difference between the remaining jump times and the single jump step length is not 0 and the difference is less than 0, determining that the jump to be executed by the target jump instruction is the last jump.

15. The electronic device according to claim 13, wherein, the RISC-V branch prediction method further comprises:
appending a jump end mark to a target jump instruction that does not need to execute the next jump.

16. The electronic device according to claim 14, wherein, the RISC-V branch prediction method further comprises:
appending a jump end mark to a target jump instruction that does not need to execute the next jump.

17. A computer readable storage medium, wherein, the computer readable storage medium has a computer program stored thereon, and the computer program, when being executed by the processor, implements a RISC-V branch prediction method comprising:
acquiring remaining jump times of a target jump instruction;
calculating a single jump step length according to the remaining jump times respectively corresponding to two consecutive jumps of the target jump instruction;
determining whether the jump to be executed by the target jump instruction is the last jump according to the single jump step length and the remaining jump times;
if the jump to be executed by the target jump instruction is the last jump, executing the last jump to the target jump instruction;
if the jump to be executed by the target jump instruction is not the last jump, proceeding to execute the next jump to the target jump instruction.

18. The computer readable storage medium according to claim 17, wherein, the determining whether the jump to be executed by the target jump instruction is the last jump according to the single jump step length and the remaining jump times comprises:
judging whether the difference between the remaining jump times and the single jump step length is 0;
if the difference between the remaining jump times and the single jump step length is 0, determining that the jump to be executed by the target jump instruction is the last jump;
if the difference between the remaining jump times and the single jump step length is not 0 and the difference is greater than 0, determining that the jump to be executed by the target jump instruction is not the last jump; and
if the difference between the remaining jump times and the single jump step length is not 0 and the difference is less than 0, determining that the jump to be executed by the target jump instruction is the last jump.

19. The computer readable storage medium according to claim 17, the RISC-V branch prediction method further comprises:
appending a jump end mark to a target jump instruction that does not need to execute the next jump.

20. The computer readable storage medium according to claim 18, the RISC-V branch prediction method further comprises:
appending a jump end mark to a target jump instruction that does not need to execute the next jump.
